(19) United States
(12) Patent Application Publication
(10) Pub. No.: US 2021/0176982 A1
(43) Pub. Date: Jun. 17, 2021

(54) CAMERA SYSTEM AND METHOD FOR MONITORING ANIMAL ACTIVITY

(71) Applicant: Plano Molding Company, LLC, Plano, IL (US)

(72) Inventors: Ryan KLECKNER, Grand Prairie, TX (US); Raymond DIKUN, Grand Prairie, TX (US); Brady ARVIEW, Grand Prairie, TX (US)

(21) Appl. No.: 17/114,719

(22) Filed: Dec. 8, 2020

Related U.S. Application Data
(60) Provisional application No. 62/946,775, filed on Dec. 11, 2019.

(51) Int. Cl. A01M 31/00; A01K 29/00; G06K 9/00

(52) U.S. Cl. CPC A01M 31/002; G06K 9/00771; A01K 29/005

(57) ABSTRACT

An animal tracking solution for remotely viewing, identifying, tracking, monitoring or predicting an animal or animal activity, or for generating a heatmap of animal activity for a geographic location. The system includes an interface that receives real-time image data from an image pickup device over a cellular communication link, an animal identification unit arranged to analyze the real-time image data from the image pickup device and identify an animal in the image data, including a species of the animal, and a user dashboard unit arranged to generate and transmit image rendering data and instruction signals to a hub communication device to render a display image on a graphic user interface that includes at least one of a near-real-time video stream from the image pickup device, an image of the animal, information about the animal, a heatmap, and a forecast.

### CROSS-REFERENCE TO PRIOR APPLICATION

The present application claims the benefit of and priority to provisional U.S. patent application Ser. No. 62/946,775, filed on Dec. 11, 2019, titled, “Camera System and Method for Monitoring Animal Activity,” which is hereby incorporated herein by reference in its entirety, as if fully set forth herein.

### FIELD OF THE DISCLOSURE

The disclosure relates generally to a method, system and computer program for monitoring and predicting animal activity in one or more geographical locations, and/or for detecting, identifying, monitoring, or tracking a particular animal, or for predicting animal behavior in one or more geographical locations.

### BACKGROUND OF THE DISCLOSURE

Trail or game cameras are typically used by users who wish to capture an image of an animal in its natural habitat without interfering with the surroundings or alerting the animal to the user's presence, or where the user does no have any prior knowledge regarding when the animal might appear at a location. An unmet need exists for a camera system that allows a user to place one or more cameras strategically in an environment to detect, monitor and image an animal in its natural habitat, without alerting the animal to the user's presence, and regardless of when the animal might appears in the environment.

### SUMMARY OF THE DISCLOSURE

An animal tracker solution is provided that can monitor and predict animal activity in one or more geographical locations. The animal tracker solution includes a system and computer-implemented method that can analyze image data and detect, identify, score, monitor or track a particular animal in one or more geographical locations. The animal tracker system and computer-implemented method can predict animal behavior, including animal activity in one or more geographic locations.

The animal tracker system can include software and hardware to remotely view, score, or predict animal activity in one or more geographic areas. The hardware can include one or more image pickup units such, for example, trail cameras. Information can be shared with groups or individuals for the purpose of competitive sharing or group comparison. Training or tips for improvement can be made based of the information collected.

The animal tracker system can include an imaging/forecasting system that can link over the air (via radio transceiver) for wireless connection to a remote receiver (for example, Cloud storage, cell phone, tablet, or computer) that can be used to parse an incoming data stream, make determinations (for example, scoring or position of shot placement, grouping, repeatability, reproducibility), and display results on terminal receiver device(s). The receiver can include a hub communication device. Terminal receiver can make determinations—for example, via a remote serve—to share results with groups or individuals and make target selections to be displayed by the receiver.

According to a nonlimiting embodiment of the disclosure, an animal tracker system is provided for identifying or monitoring an animal in a geographic area. The system comprises an interface that receives real-time image data from an image pickup device over a cellular communication link; an animal identification unit arranged to analyze the real-time image data from the image pickup device and identify an animal in the image data, including a species of the animal; and, a user dashboard unit arranged to generate and transmit image rendering data and instruction signals to a hub communication device to render a display image on a graphic user interface that includes at least one of a near-real-time video stream from the image pickup device, an image of the animal, information about the animal, a heatmap, and a forecast. The information about the animal can include a score value for the animal, a species of the animal, a historical activity tracking map for the animal, or a predicted activity map for the animal. The system can comprise a scoring unit arranged to interact with the animal identification unit and determine a score value for the animal, and/or an animal event predictor arranged to analyze historical image data and predict an activity for the animal, and/or an animal event predictor arranged to analyze historical image data and predict animal activity at a geographic location. The animal can include a Buck and the scoring unit is arranged to determine the score value for the Buck based on a Boone and Crocket Scale. The hub communication device can comprise a smartphone or computer tablet.

According to another nonlimiting embodiment of disclosure, a computer-implemented method is provided for identifying, monitoring and tracking an animal in a geographic area. The method comprises receiving real-time image data at an interface from an image pickup device over a cellular communication link, analyzing the real-time image data by a machine intelligence platform to identify an animal in the image data, including a species of the animal, generating image rendering data and instruction signals based on the analyzed real-time image data, and transmitting the image rendering data and instruction signals to a hub communication device to render a display image on a graphic user interface that includes at least one of a near-real-time video stream from the image pickup device, an image of the animal, information about the animal, a heatmap, and a forecast. The method can comprise determining a score value for the animal, and/or analyzing historical image data, and/or predicting an activity for the animal, and/or predicting animal activity at a geographic location. In the method: the information about the animal can include a score value for the animal, a species of the animal, a historical activity tracking map for the animal, or a predicted activity map for the animal; and/or the animal can include a Buck and the scoring determining the score value for the animal comprises performing a Boone and Crocket Scale analysis of the image data; and/or the hub communication device can comprise a smartphone or computer tablet.

According to another nonlimiting embodiment of the disclosure, a non-transitory computer-readable storage medium containing animal monitoring program instructions is provided for identifying or monitoring an animal in a geographic area. The program instructions, when executed on a processor, cause an operation to be carried out, comprising: receiving real-time image data at an interface from an image pickup device over a cellular communication link; analyzing the real-time image data by a machine intelligence platform to identify an animal in the image data, including a species of the animal; generating image rendering data and instruction signals based on the analyzed real-time image data; and transmitting the image rendering data and instruction signals to a hub communication device to render a display image on a graphic user interface that includes at least one of a near-real-time video stream from the image pickup device, an image of the animal, information about the animal, a heatmap, and a forecast. The program instructions can, when executed on the processor, cause a further operation of: determining a score value for the animal; and/or analyzing historical image data; and/or predicting an activity for the animal; and/or predicting animal activity at a geographic location. In the storage medium: the information about the animal can include a score value for the animal, a species of the animal, a historical activity tracking map for the animal, or a predicted activity map for the animal; and/or the animal includes a Buck and the scoring determining the score value for the animal comprises performing a Boone and Crocket Scale analysis of the image data; and/or the hub communication device can comprise a smartphone or computer tablet.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows a nonlimiting example of an animal tracking solution in a user environment, according to the principles of the disclosure.

FIG. 2A shows a nonlimiting embodiment of an identification, tracking, scoring or prediction (ITSOP) system that can be included in the animal tracking solution.

FIG. 2B shows a nonlimiting example of communication link configurations in the ITSOP system shown in FIG. 2A.

FIG. 3 shows three nonlimiting examples of an image pickup unit that can be included in the ITSOP system shown in FIGS. 2A or 2B.

FIG. 4 shows a nonlimiting embodiment of an ITSOP server that can be included in the ITSOP system shown in FIGS. 2A or 2B.

FIG. 5 shows an example of an animal species identification graphic user interface (GUI) screen that can be rendered and displayed by a hub communication device (HCD) in the ITSOP system shown in FIGS. 2A or 2B.

FIG. 6 shows an example an animal tracking GUI screen that can be rendered and displayed by the HCD in the ITSOP system shown in FIGS. 2A or 2B.

FIGS. 7 and 8 show examples of activity heatmap GUI screens that can be rendered and displayed by HCD in the ITSOP system shown in FIGS. 2A or 2B.

FIG. 9 shows an example of a hunt forecast GUI screen that can be rendered and displayed by the HCD in the ITSOP system shown in FIGS. 2A or 2B.

FIG. 10 shows an example of a GUI screen that can be rendered and displayed by the HCD in the ITSOP system, shown in FIGS. 2A or 2B, to view, sort and organize trail cam photos.

FIG. 11 shows an example of a GUI screen that can be rendered and displayed by the HCD in the ITSOP system, shown in FIGS. 2A or 2B, to create unique tags to categorize photos in groups.

FIG. 12 shows an example of a GUI screen that can be rendered and displayed by the HCD in the ITSOP system, shown in FIGS. 2A or 2B, to auto-load photos saved at camera locations.

FIG. 13 shows an example of a process that can be carried out by the ITSOP system shown in FIGS. 2A or 2B.

The present disclosure is further described in the detailed description and drawings that follows.

### DETAILED DESCRIPTION OF THE DISCLOSURE

The embodiments of the disclosure and the various features and advantageous details thereof are explained more fully with reference to the non-limiting embodiments and examples that are described or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated. Descriptions of well-known components and processing techniques can be omitted so as to not unnecessarily obscure the embodiments of the disclosure. The examples are intended merely to facilitate an understanding of ways in which the disclosure can be practiced and to further enable those of skill in the art to practice the embodiments of the disclosure. Accordingly, the examples and embodiments should not be construed as limiting the scope of the disclosure, which is defined solely by the appended claims and applicable law. Moreover, it is noted that like reference numerals represent similar parts throughout the several views of the drawings.

Identification and monitoring of animals and animal behavior is of great interest in a variety of fields, including ethology, animal husbandry, research, animal watching (such as, for example, bird watching), and hunting, among others. Animal identification can be challenging, if not impossible in certain instances, given the variety and diversity of species; and, animal monitoring can be extremely resource intensive and costly. There exists a great need for an animal tracking solution that can accurately identify and monitor animals, as well as predict animal behavior.

The field of machine intelligence (MI) has made rapid progress in recent years, especially with respect to computer vision. Computer vision generally is an interdisciplinary scientific field that deals with how computers can gain a high-level understanding from digital images or videos. MI can provide a computer vision solution that can automatically extracts features from image data, classify image pixel data and identify objects in image data. Recent breakthroughs in machine intelligence have occurred due to advancements in hardware such as graphical processing units, availability of large amounts of data, and developments in collaborative community-based software algorithms. Achievements in MI-based techniques in computer vision can provide remarkable results in fields such as ethology, animal husbandry, animal research, animal watching, animal tracking, and hunting.

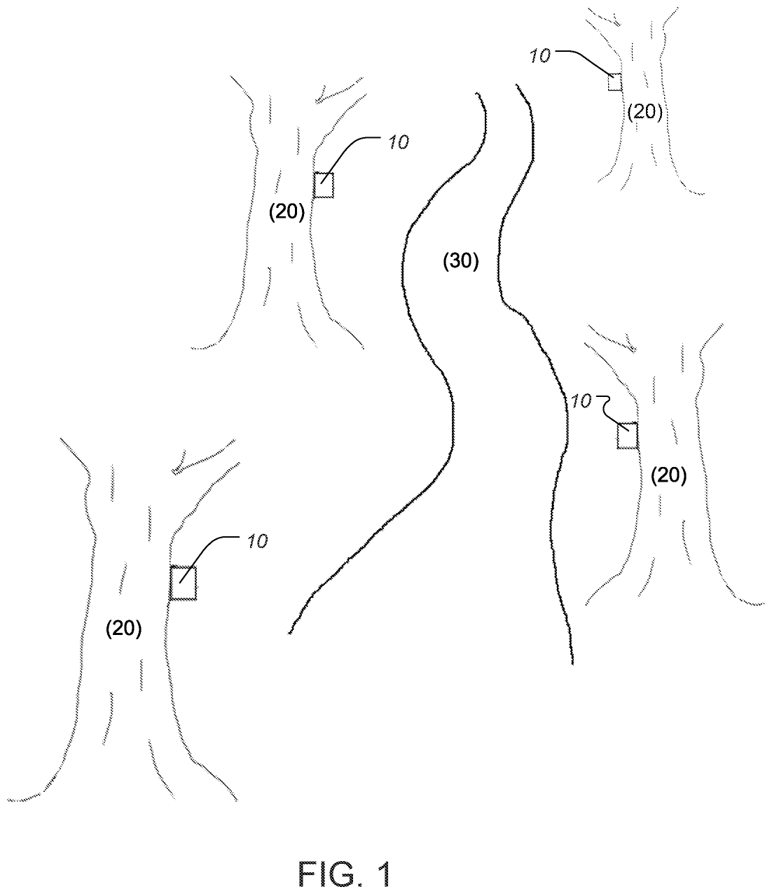

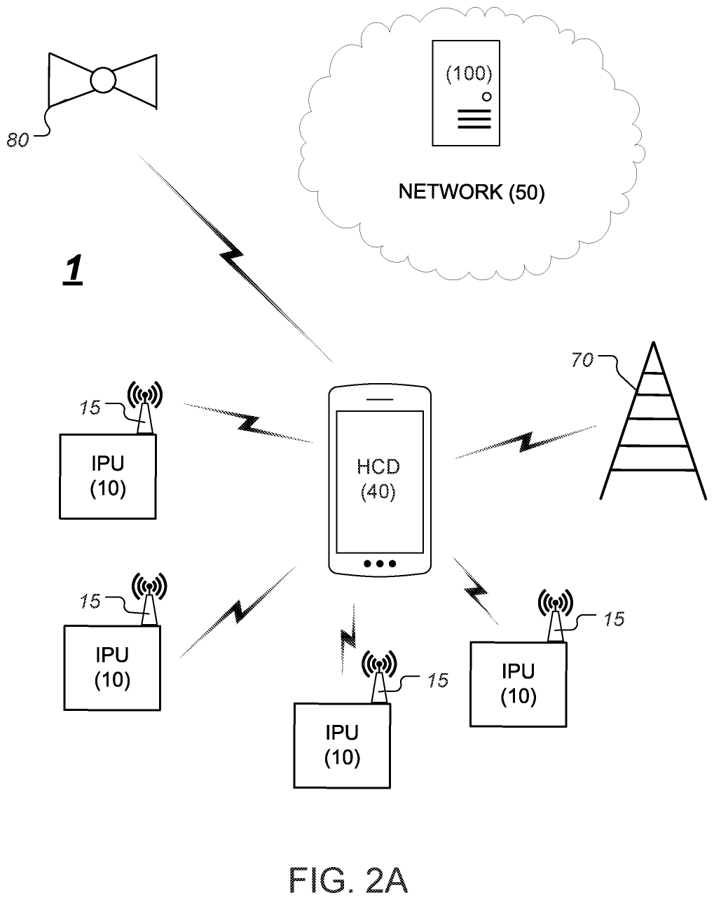

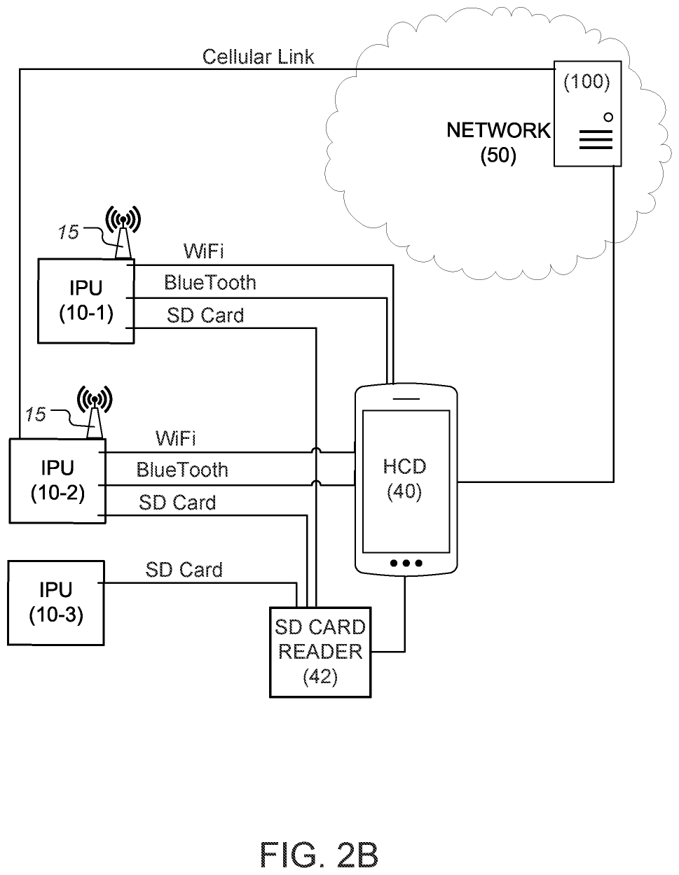

The instant disclosure provides an animal tracker system that includes machine intelligence that can detect, identify, monitor, track and/or predict animal activity. The animal tracker system can receive image data and metadata from a hub communication device (HCD) (for example, HCD 40, shown in FIGS. 2A and 2B) or from one or more image pickup units (IPU) (for example, IPU 10, shown in FIGS. 1, 2A, 2B) to detect, identify, monitor, track and/or score an animal or animal activity in one or more geolocation areas, or to predict animal activity in one or more geolocation areas. The image data can include still or moving images captured by one or more IPUs. The metadata can include information related to the image data, including, for example, a time stamp that indicates when the image(s) was captured, a geographic location where the image(s) was captured, and an identification of the IPU that captured the image. The animal tracker solution can process and analyze the image data or metadata to identify and score particular animals in captured images, determine past activities or behavior patterns for the animals, and predict future animal activity or behavior in one or more geographic locations.

FIG. 1 shows a nonlimiting example of an animal tracking system in a user environment, according to the principles of the disclosure. The user environment can include a geographic area where an animal is likely to enter or traverse, such as, an animal observation or hunting area. The animal tracking solution can include one or more image pickup units (IPUs) 10 and one or more objects 20 to which the IPUs 10 can be attached. The user environment can include a trail 30 that may be used by an animal when traversing the area. The IPUs 10 can be positioned for maximal likelihood of capturing an image of an animal in the area.

FIG. 2A shows a nonlimiting embodiment of an identification, tracking, scoring or prediction (ITSOP) system 1 that can be included in the animal tracking solution, according to the principles of the disclosure. The ITSOP system 1 can include one or more IPUs 10. The ITSOP system 1 can include a hub communication device (HCD) 40. The ITSOP system 1 can include an ITSOP server 100. The ITSOP server 100 can be located in a computer network 50 such as, for example, a cloud network that is accessible through the Internet. The ITSOP server 100 can exchange data or instruction signals with the HCD 40 or IPUs 10 over one or more communication links. The HCD 40 (or IPUs 10) can communicate data or instruction signals to the ITSOP server 100 over a cellular communication link 70 or a satellite communication link 80.

The HCD 40 can include a smartphone, tablet, or other portable communication device. The HCD 40 can include, for example, an iPHONE® or iPAD®. Data and instruction signals can be exchanged between the HCD 40 and IPU(s) 10 over a communication link or by means of a device, such as, for example, a secure digital (SD) card reader 42 (shown in FIG. 2B), flash drive or other removal storage device. For example, image data captured by the IPU 10 can be transmitted to the HCD 40 via a communication link or a removal storage device that can be removed from the IPU 10 and connected to the HCD 40 (directly or through the SD card reader 42) to download the image data to the HCD 40.

The IPU 10 can include one or more sensors that can measure ambient conditions, including weather conditions, or receive ambient condition data for the geographic location of the IPU 10 from an external data source, such as, for example, a weather service server (not shown) via a communication link. The ambient conditions can include, for example, temperature, pressure, humidity, precipitation, wind, wind speed, wind direction, light level, or sun/cloud conditions, and any changes in the foregoing as function of time for the geographic location.

The HCD 40 can be configured as a hotspot for the IPUs 10. An IPU 10 can be configured as a hotspot for other IPUs 10 or the HCD 40.

FIG. 2B shows a nonlimiting example of communication link configurations in the ITSOP system 1. As seen in FIG. 2B, the IPUs 10 can include: an IPU 10-1 that can be configured for WiFi or BlueTooth communication with the HCD 40; an IPU 10-2 that can be configured for direct communication with the ITS OP server 100 via, for example, a cellular communication link, in addition to WiFi or BlueTooth communication; and, an IPU 10-3 that does not include any communication links and, instead, relies on a hardware storage device such as an SD card to store and transfer image data to the HCD 40. Each of the IPUs 10 can be configured to store image data to a hardware storage device and transfer stored data to the HCD 40 via an interconnected reader 42, such as, for example, an SD card reader. The configuration shown in FIG. 2B allows for real-time image capture by the IPU 10-2 and upload to the ITSOP server 100 to allow for real-time animal identification, monitoring, and tracking, as well as remote viewing at the HCD 40.

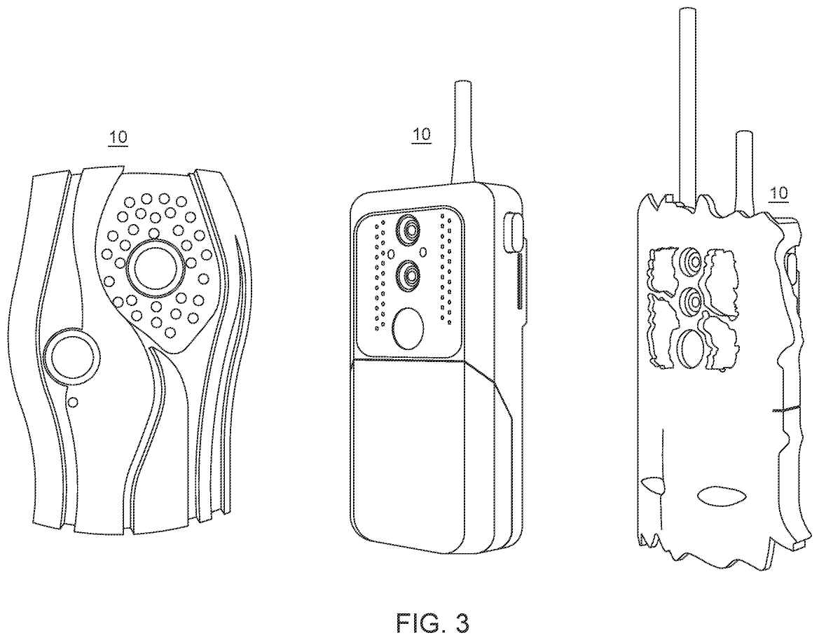

FIG. 3 shows three nonlimiting examples of an IPU 10 that can be included in the ITSOP system 1. The IPU 10 can include a camera device, such as, for example, a wireless trail camera that can be attached to a tree or other object. The IPU 10 can include a stereoscopic camera device that can capture a three-dimensional (3D) image. The IPU 10 can include a three-dimensional (3D) or depth camera that can capture visible and infrared images and output image data and 3D point cloud data. The IPU 10 can include an Internet-of-Things (IoT) device such as an IOT camera. The IPU 10 can include a motion sensor (not shown) that can cause the IPU 10 to begin or stop image capture based on, for example, detection of movement of an animal in an area near the IPU 10. The IPU 10 can include a transceiver (transmitter and receiver) that can transmit or receive WiFi, BlueTooth, cellular, satellite, radio frequency (RF), infrared (IR), or any other type of communication signal.

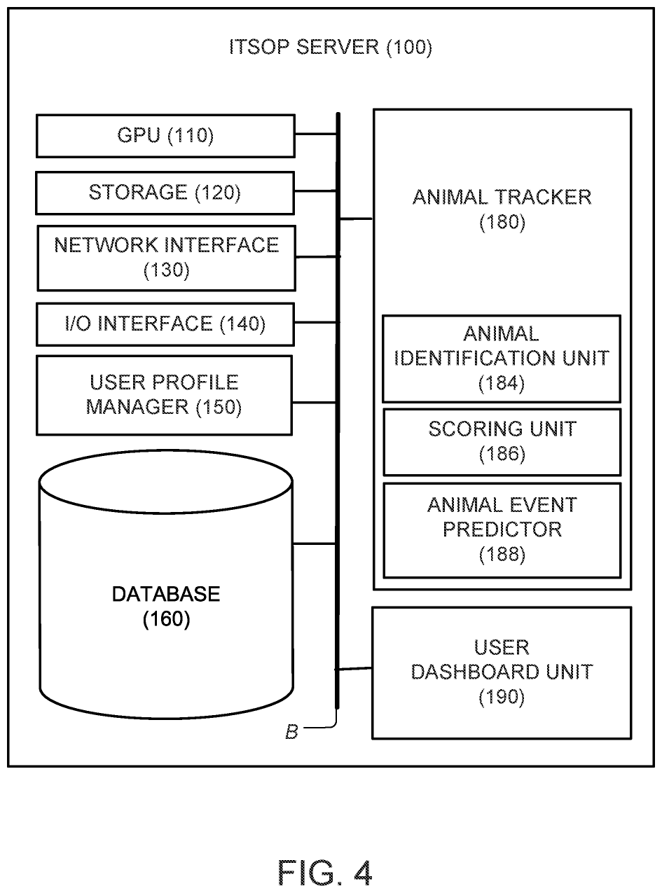

FIG. 4 shows a nonlimiting embodiment of the ITSOP server 100, constructed according to the principles of the disclosure. The ITSOP server 10 can include a graphic processor unit (GPU) 110, a storage 120, a network interface 130, an input-output (I/O) interface 140, a user profile manager 150, a database 160, an animal tracker 180, and a user dashboard unit 190. The components 110 to 190 can be connected to a backbone B by means of one or more communication links.

The ITS OP server 100 can include a non-transitory computer-readable storage medium that can hold executable or interpretable computer code (or instructions) that, when executed by one or more of the components (for example, the GPU 110), cause the steps, processes and methods described in this disclosure to be carried out. The computer-readable medium can be included in the storage 120, or an external computer-readable medium connected to the ITSOP server 100 via the network interface 130 or the I/O interface 140.

The GPU 110 can include any of various commercially available graphic processors, processors, microprocessors or multi-processor architectures. The GPU 110 can include a plurality of GPUs that can execute computer program instructions in parallel. The GPU 110 can include a central processing unit (CPU) or a plurality of CPUs arranged to function in parallel.

A basic input/output system (BIOS) can be stored in a non-volatile memory in the ITSOP server 100, such as, for example, in the storage 120. The BIOS can contain the basic routines that help to transfer information between computing resources within the ITSOP server 100, such as during start-up.

The storage 120 can include a read-only memory (ROM), an erasable programmable read-only memory (EPROM), an electrically erasable programmable read-only memory (EEPROM), a random-access memory (RAM), a non-volatile random-access memory (NVRAM), a dynamic random-access memory (DRAM), a synchronous dynamic random-access memory (SDRAM), a static random-access memory (SRAM), a burst buffer (BB), or any other device that can store digital data and computer executable instructions or code.

A variety of program modules can be stored in the storage 120, including an operating system (not shown), one or more application programs (not shown), application program interfaces (APIs) (not shown), program modules (not shown), or program data (not shown). Any (or all) of the operating system, application programs, APIs, program modules, or program data can be cached in the storage 120 as executable sections of computer code.

The network interface 130 can be connected to the network 50, a network formed by the IPUs 10 and HCD 40, or one or more external networks (not shown). The network interface 130 can include a wired or a wireless communication network interface (not shown) or a modem (not shown). When communicating in a local area network (LAN), the ITSOP server 100 can be connected to the LAN network through the wired or wireless communication network interface; and, when communicating in a wide area network (WAN), the ITS OP server 100 can be connected to the WAN network through the modem. The modem (not shown) can be internal or external and wired or wireless. The modem can be connected to the backbone B via, for example, a serial port interface (not shown).

The I/O interface 140 can receive commands and data from, for example, an operator via a user interface device (not shown), such as, for example, a keyboard (not shown), a mouse (not shown), a pointer (not shown), a microphone (not shown), a speaker (not shown), or a display (not shown). The received commands and data can be forwarded to the GPU 110, or one or more of the components 120 through 190 as instruction or data signals via the backbone B.

The network interface 130 can include a data parser (not shown) or the data parsing operation can be carried out by the GPU 110. Received image data (with or without metadata) can be transferred from the network interface 130 to the GPU 110, database 160, or animal tracker 180. The network interface 130 can facilitate communication between any one or more of the components in the ITS OP server 100 and computing resources located internal (or external) to the network 50. The network interface 130 can handle a variety of communication or data packet formats or protocols, including conversion from one or more communication or data packet formats or protocols used by the IPUs 10 or HCD 40 to the communication or data packet formats or protocols used in the ITSOP server 100.

The user profile manager 150 can include a computing device or it can be included in a computing device as a computer program module or API. The user profile manager 150 can create, manage, edit, or delete an ITSOP record for each user and HCD 40 or IPU 10 (shown in FIG. 2), including, for example, a user identification, an email address, a user name, a media access control (MAC) address, an Internet Protocol (IP) address, or any other user or device identification. The user profile manager 150 can interact with the database 160 to search, retrieve, edit or store ITSOP records in the database 160. The user profile manager 150 can manage and link multiple user profiles to enable group or individual-to-individual sharing of information, including animal identification data, animal tracking data, animal scoring data, heatmap data, or animal activity forecasting data.

The database 160 can include one or more relational databases. The database 160 can include ITSOP records for each user and/or HCD 40 or IPU 10 that has accessed or may be given access to the ITSOP server 100. The ITSOP records can include historical data for each user, HCD 40 and IPU 10, including image data and metadata for each geographic area where images were captured by IPUs 10. Each ITSOP record can include real-world geographic coordinates such as Global Positioning System (GPS) coordinates for each image frame, time when the image was captured, identification of the IPU 10 that captured the image. The ITSOP record can include weather conditions when the image was captured, such as, for example, temperature, air pressure, wind direction, wind speed, humidity, precipitation, or any other information that might be useful in determining animal activity or behavior.

The animal tracker 180 can include one or more computing devices or it can be included in a computing device as one or more computer program modules or APIs. The animal tracker 180 can include an animal identification unit 184, a scoring unit 186 or an animal event predictor 188, any of which can include a computing device or be included in a computing device as one or more modules. The animal tracker 180 can include a supervised or unsupervised machine learning system, such as, for example, a Word2vec deep neural network, a convolutional architecture for fast feature embedding (CAFFE), an artificial immune system (AIS), an artificial neural network (ANN), a convolutional neural network (CNN), a deep convolutional neural network (DCNN), region-based convolutional neural network (R-CNN), you-only-look-once (YOLO), a Mask-RCNN, a deep convolutional encoder-decoder (DCED), a recurrent neural network (RNN), a neural Turing machine (NTM), a differential neural computer (DNC), a support vector machine (SVM), a deep learning neural network (DLNN), Naive Bayes, decision trees, logistic model tree induction (LMT), NBTree classifier, case-based, linear regression, Q-learning, temporal difference (TD), deep adversarial networks, fuzzy logic, K-nearest neighbor, clustering, random forest, rough set, or any other machine learning platform capable of supervised or unsupervised learning. The animal tracker 180 can include a machine learning model that is trained using large training datasets comprising, for example, thousands, hundreds of thousands, millions, or more annotated images. The annotated images can include augmented images. The machine learning model can be trained to detect, classify and identify wildlife species in image data received from the IPUs 10. The machine learning model can be validated using testing image datasets for each animal type or species.

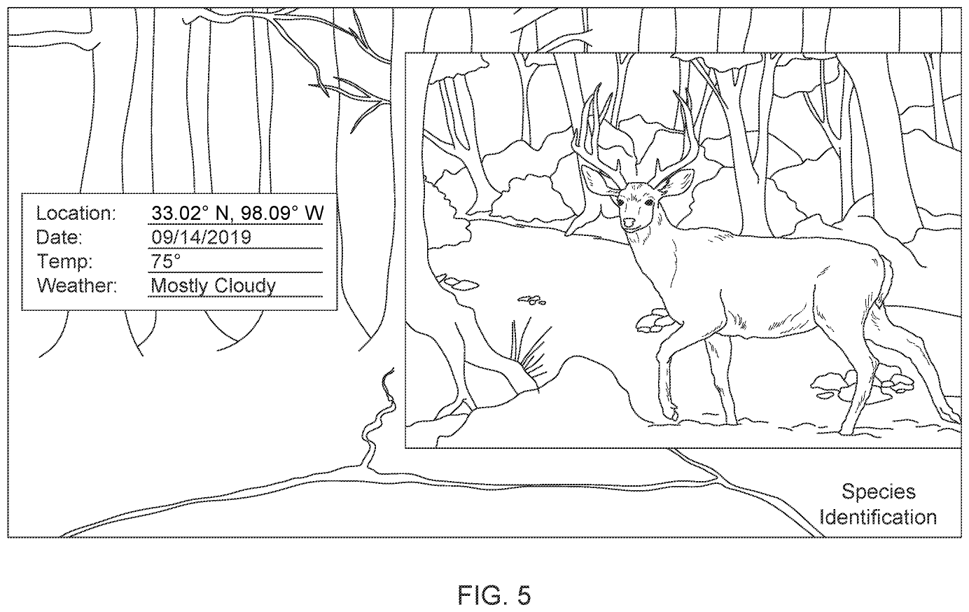

The animal tracker 180 can be arranged to analyze image data and identify or score an animal in the image data, including the species of the animal, as seen in the nonlimiting example shown in FIG. 5. The animal tracker 180 can monitor and track the animal over time, including all geographic locations where an image of the animal was previously captured by an IPU 10 (or HCD 40), or loaded to the ITSOP server 100 via, for example, the network interface 130 or I/O interface 140.

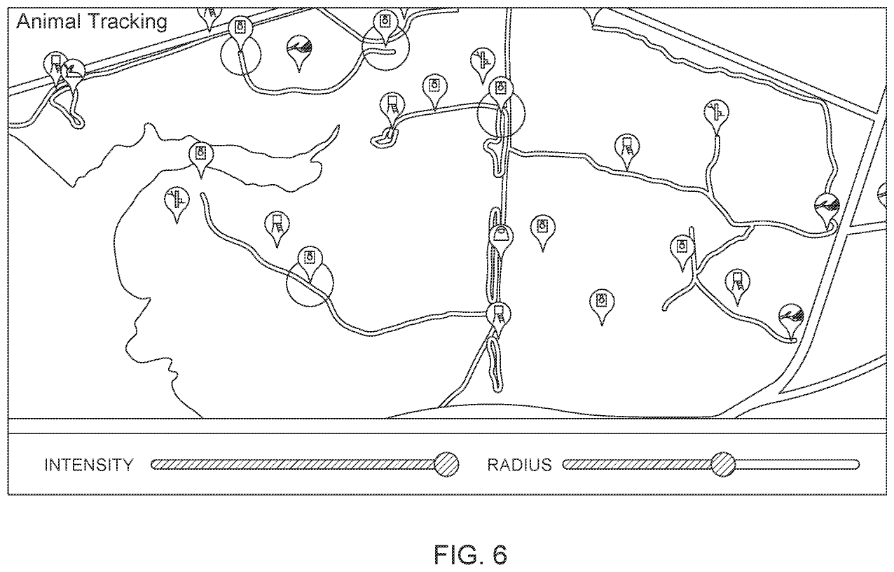

FIG. 6 shows a nonlimiting example of a graphic user interface (GUI) screen that can be generated based on the animal tracking information generated by the animal tracker 180.

Based on historical data, such as the ITSOP records stored in the database 160, the animal tracker 180 can predict activity or behavior of the animal, including a time and location where the animal is likely to appear. The animal tracker 180 can generate activity heatmaps for one or more animals, or for one or more geographic locations.

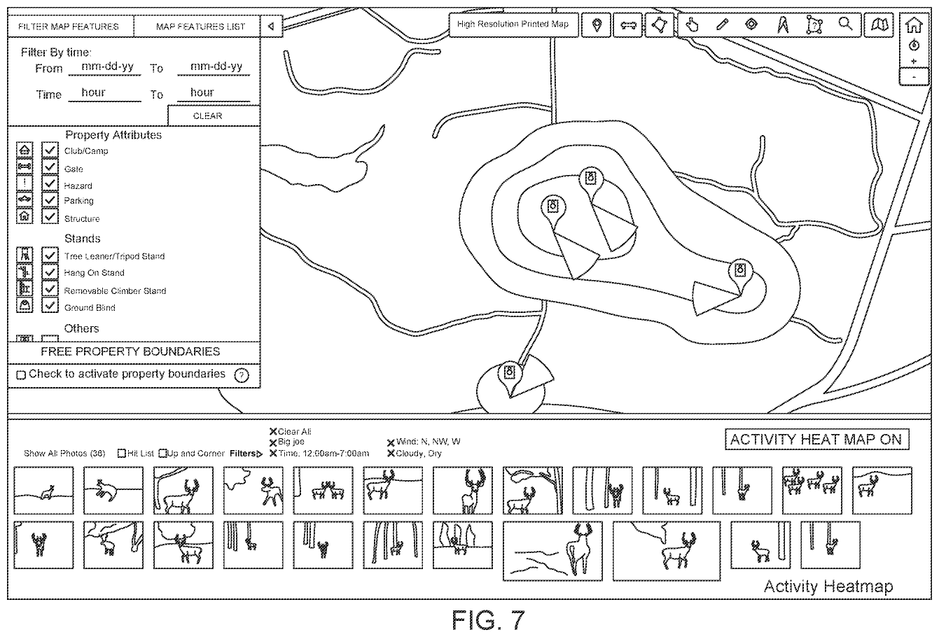

FIG. 7 shows a nonlimiting example of a GUI screen that can be generated based on the activity heatmaps generated by the animal tracker 180.

The GUI screens depicted in FIG. 5, 6 or 7 can be rendered and displayed on the HCD 40 (shown in FIG. 2) in response to data and instructions transmitted from the ITSOP server 100 to the HCD 40.

The animal tracker can aggregate one or more ITSOP records, including historical image data, for a plurality of geographic locations, users or HCDs 40 (or IPUs 10) and analyze image data to predict activity heatmaps or animal activity in a wide range of locations, including geographic locations where a particular user or HCD 40 may have never visited.

The animal identification unit 184 can parse image data received from the IPUs 10 (shown in FIGS. 1, 2A and 2B) and associate each pixel in the image data of an image with a classification label. The animal identification unit 184 can include, for example, a convolutional neural network (CNN) or deep convolutional neural network (DCNN) for animal classification. The animal classification can include a species of the animal, including descriptive identification information. The animal classification can include, for example Buck, Doe, Pig, Coyote, Bobcat, or any other species of animal. The animal identification unit 184 can interact with the database 160 to query, retrieve and compare historical image data to the received image data and identify the specific animal in the received image data.

The animal identification unit 184 can parse metadata that is received with the image data and determine geographic location coordinates, time, and ambient conditions when the image in the associated image data was captured. The animal identification unit 184 can analyze the metadata and animal identification information and update parameters in a machine learning model (for example, ANN, CNN, DCNN, RCNN, NTM, DNC, SVM, or DLNN) to build an understanding of the particular animal and its behavior as a function of time and ambient conditions, among other things, so as to be able to predict the animal's behavior in the future.

In a nonlimiting embodiment, the animal identification unit 184 includes a CNN, which can be based on a proprietary platform or a readily available object detection and classification platform, such as, for example, the open source You-Only-Look-Once (YOLO) machine learning platform. The animal identification unit 184 can be initially trained using one or more large-scale object detection, segmentation, and captioning datasets, such as, for example, the Common Objects in Context (COCO) dataset, the PASCAL VOC 2012 or newer dataset, or any other dataset that can be used to train a CNN or DCNN. The COCO dataset is available at, for example, <www.cocodataset.org> or <deepai.org>.

Once trained, the animal identification unit 184 can detect, classify and track animals in real time in image data received from the IPUs 10 (shown in FIGS. 1, 2A and 2B). In this embodiment, the CNN can have a minimal number of convolutional and pooling layers (for example, 2 convolutional layers and 2 pooling layers) and a single fully connected layer. However, in other embodiments, the CNN can include a deep CNN (or DCNN) having 10, 20, 30, or more convolutional-pooling layers followed by multiple fully connected layers.

The animal identification unit 184 can be configured to analyze every pixel in the received image data and make a prediction at every pixel. The animal identification 184 can receive image data from each of the IPUs 10 and format each image data stream into, for example, multi-dimensional pixel matrix data (for example, 2, 3 or 4-dimensional matrices), including an n×m matrix of pixels for each color channel (for example, R, G, B) and, optionally, infrared (IR) channel, where n and m are positive integers greater than 1.

After formatting the received image data for each IPU 10 into R, G, B (and/or IR) matrices of n×m pixels each, the animal identification unit 184 can filter each pixel matrix using, for example, a 1×1, 2×2 or 3×3 pixel grid filter matrix. The animal identification unit 184 can slide and apply one or more pixel grid filter matrices across all pixels in each n×m pixel matrix to compute dot products and detect patterns, creating convolved feature matrices having the same size as the pixel grid filter matrix. The animal identification unit 184 can slide and apply multiple pixel grid filter matrices to each n×m pixel matrix to extract a plurality of feature maps.

Once the feature maps are extracted, the feature maps can be moved to one or more rectified linear unit layers (ReLUs) in the CNN to locate the features. After the features are located, the rectified feature maps can be moved to one or more pooling layers to down-sample and reduce the dimensionality of each feature map. The down-sampled data can be output as multidimensional data arrays, such as, for example, a 2D array or a 3D array. The resultant multidimensional data arrays output from the pooling layers can be flattened into single continuous linear vectors that can be forwarded to the fully connected layer. The flattened matrices from the pooling layer can be fed as inputs to the fully connected neural network layer, which can auto-encode the feature data and classify the image data. The fully connected layer can include one or more hidden layers and an output layer.

The resultant image cells can predict the number of bounding boxes that might include an animal, as well as confidence scores that indicate the likelihood that the bounding boxes might include the animal. The animal identification unit 184 can include bounding box classification, refinement and scoring based on the animal in the image represented by the image data and determine probability data that indicates the likelihood that a given bounding box contains the animal.

The scoring unit 186 can be constructed as a separate device, computer program module or API, or it can be integrated with the animal identification unit 184. The scoring unit 186 can be configured to compare characteristics of the animal in the image data against other animals in the same species or a standard assessment and determine an animal score value. For example, the scoring unit 186 can analyze characteristics of a Buck in an image frame and, using the Boone and Crocket Scale, determine the animal score value.

The animal event predictor 188 can interact with the user profile manager 150, database 160, animal identification unit 184 or scoring unit 186 and predict animal activity or behavior for each animal or geographic location as a function of, among other things, time, time of day, day, week, month, season, year, or ambient conditions. The animal event predictor 188 can sort ITSOP records for null, species or score values, among other things, for each animal or geographic location. The animal event predictor 188 can forecast hunt or photo opportunities, including game movement predictions for each animal type, animal, or geographic location. The animal event predictor 188 can generate heatmap data of game activity for a given geographic location or an area of geographic locations. The heatmap data can include historical, real-time or predicted animal activity for the location(s).

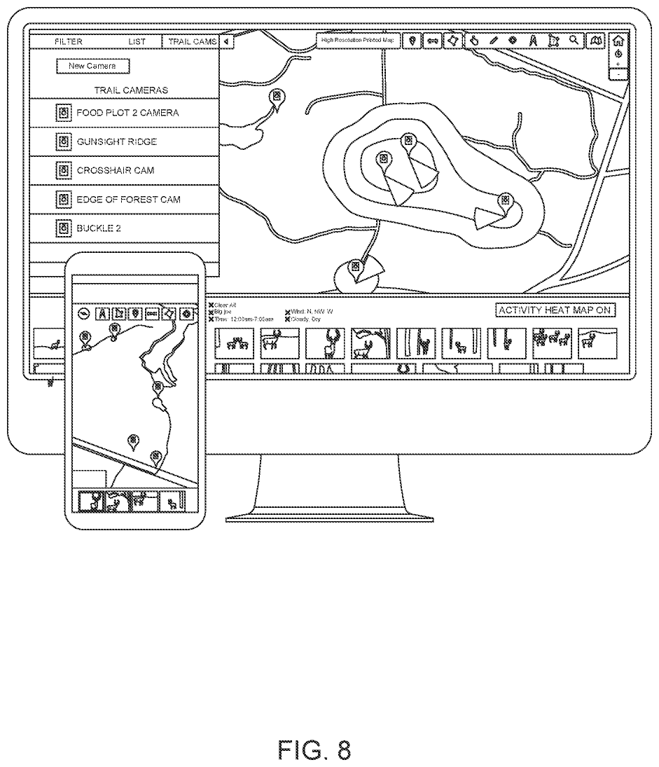

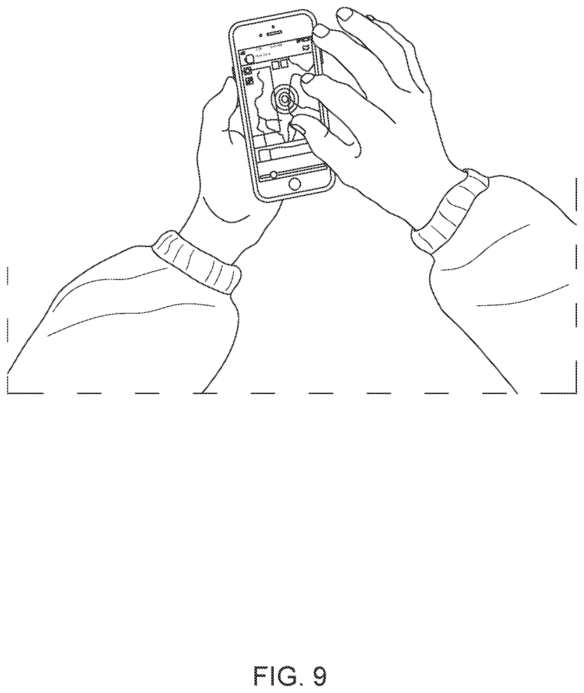

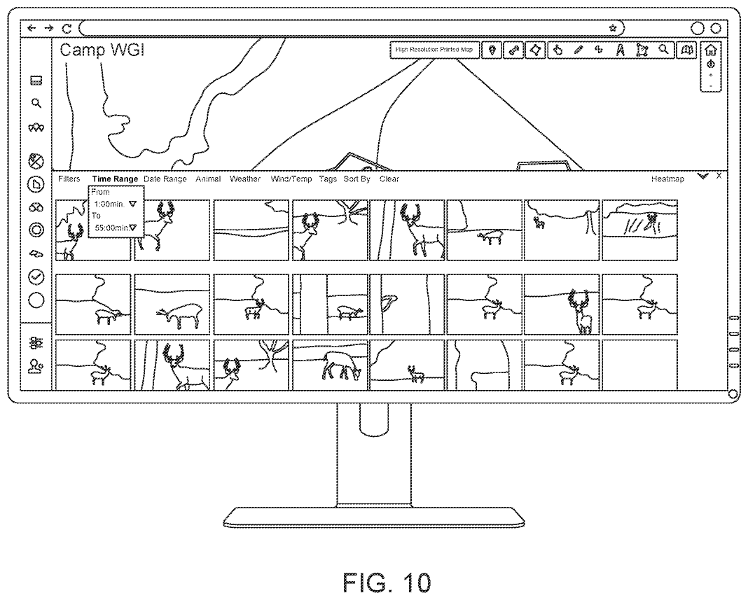

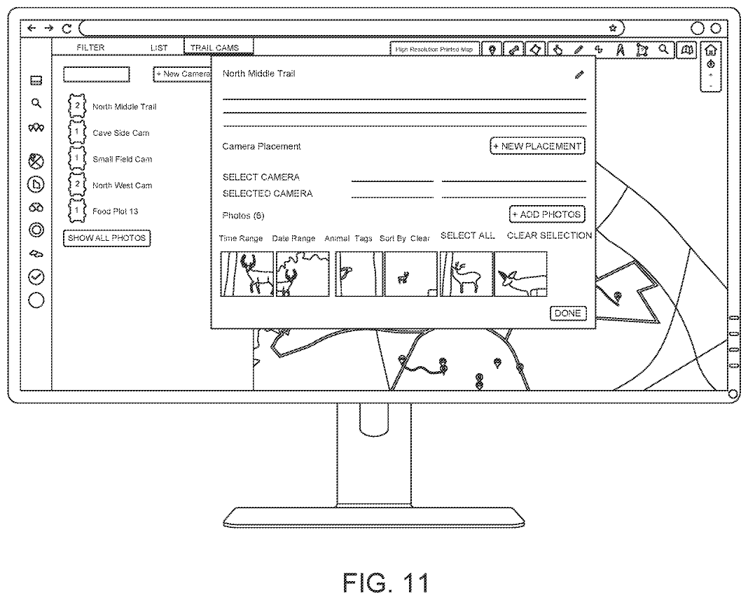

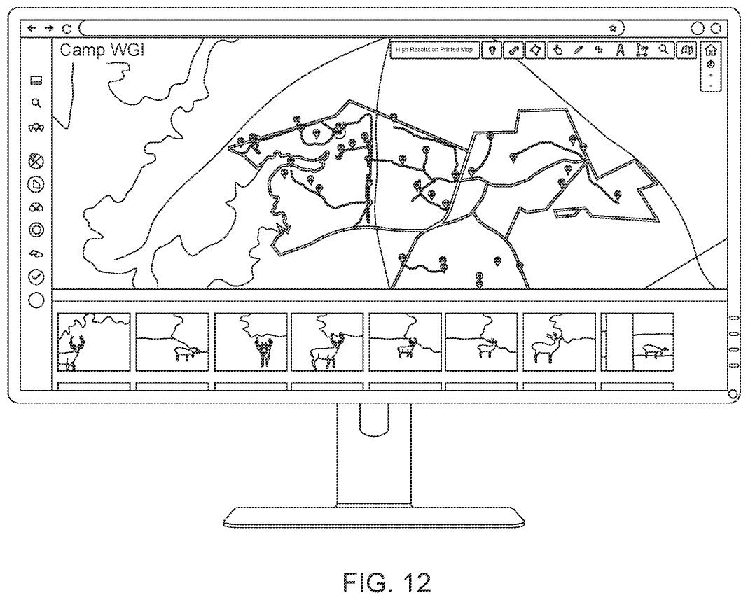

The user dashboard unit 190 can generate and transmit instructions or data to, or receive instructions or data from the HCD 40 (or IPU 10) (shown in FIG. 2) via the network interface 130 or I/O interface 140. The transmitted instructions or data can be received by the HCD 40 and used to generate a (GUI) (for example, shown in FIGS. 5-12) on a display of the HCD 40, or another computing device. The instructions received by the user dashboard unit 190 can include a request to transmit data and instructions that can be used by the HCD 40 to render and display, among other things, species identification (FIG. 5), animal tracking (FIG. 6), activity heatmaps (FIG. 7 or 8), hunt forecasts (FIG. 9), or to view, sort and organize trail cam (IPU 10) photos (FIG. 10), create unique tags to categorize photos in groups (FIG. 11), or auto-load photos saved camera (IPU 10) locations (FIG. 12). The received instructions can include filtering parameters that allow the user to drill down into photos. The data received by the user dashboard unit 190 can include, among other things, user or device identification data, such as, for example, email address, username, MAC address, IP address.

Referring to FIG. 9, using the HCD 40, a user can retrieve and display hunt forecasts from the ITSOP server 100 based on geographic location, species, or individual animal that can predict the best day or time to hunt, or which location (e.g., stand location) to in or from. Via the HCD 40, the user can remotely view, score or project target images. Additionally, the user can share (via the HCD 40) information with groups or individuals for the purpose of competitive sharing or group comparison, training or tips for improvement based of the information collected.

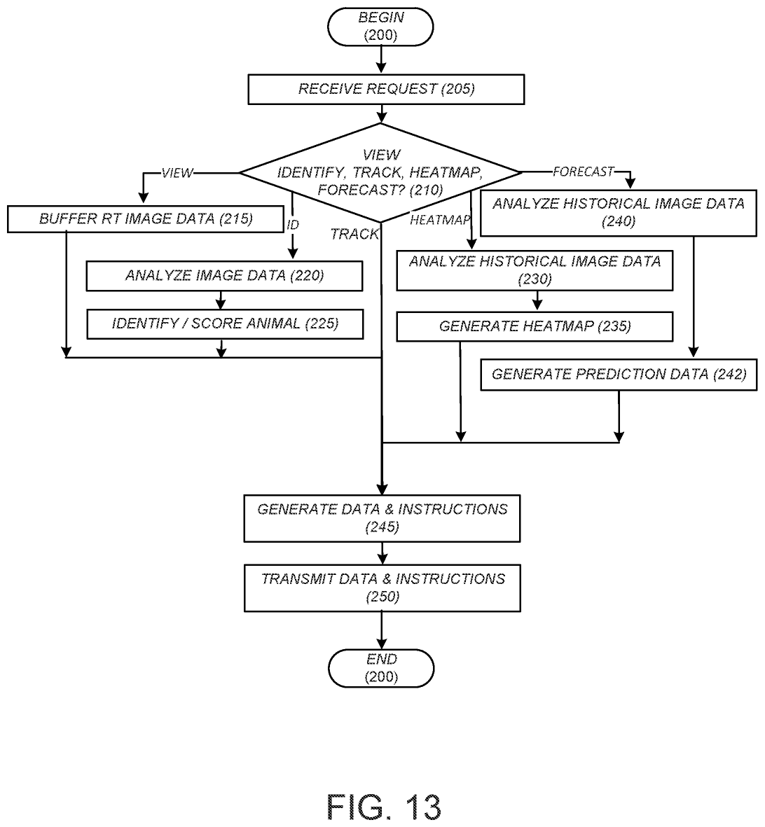

FIG. 13 shows an example of a process 200 that can be carried out by the ITSOP system 1 (shown in FIGS. 2A or 2B), or, more particularly, the ITSOP server 100 (shown in FIG. 4) that can be included in the ITSOP system 1. Referring to FIGS. 2B, 4 and 13, the ITSOP server 100 can receive a request from an HCD 40 or an IPU 10 (Step 205). The request can include a request from the HCD 40 to display image data (for example on the HCD 40 or another communication device (not shown)) captured in real-time or in the past by one or more IPUs 10. The request can include data that identifies a particular IPU 10 (for example, IPU 10-1, shown in FIG. 2B) from which the image capture data is to be received and displayed. The data can include global positioning system (GPS) coordinates for the HCD 40 and the IPU 10 can be determined automatically by the user profile manager 150 (shown in FIG. 4) based on the GPS coordinates.

If a VIEW request is received (“VIEW” at Step 210), image data from a select IPU 10 (for example, IPU 10-1, shown in FIG. 2B) can be buffered locally, for example, in the storage 120 (shown in FIG. 4) and transmitted to the HCD 40, where it can be displayed as a near-real-time live video stream of the image data captured by the IPU 10.

The request (Step 205) can include a request from the HCD 40 or IPU 10 to identify or track an animal in image data captured in real-time or in the past by an IPU 10 or the HCD 40, or image data stored or loaded into the ITS OP server 100 from another communication device (not shown), such as, for example, a desktop computer or portable computer. If an IDENTIFY request is received (IDENTIFY, at Step 210), then image data can be analyzed by the animal identification unit 184 (shown in FIG. 4) to identify the animal in the image data, including the species of the animal, and the animal can be scored by the scoring unit 186 (shown in FIG. 4) (Step 220). When analyzing the image data, the database 160 can be queried and image data can be retrieved for the animal identification unit 184 to whether the particular animal was previously imaged by, for example, determining whether an image of the particular animal was previously captured or stored in the ITS OP server 100. If the animal identification unit 184 determines the animal in the image data is a Buck (Step 225), the scoring unit 186 can analyze the image data and determine a score value for the Buck by, for example, using the Boone and Crocket Scale (Step 225).

If a TRACK request is received (TRACK, at Step 210), then animal tracking data and instructions can be generated by the user dashboard 190 (shown in FIG. 4) (Step 245) and sent to the HCD 40 to render and display a GUI screen such as, for example, seen in FIG. 6 (Step 250). When generating the tracking data and instructions, the user dashboard 190 can interact with the animal identification unit 184 or animal event predictor 188 (shown in FIG. 4) to generate or retrieve historical tracking data for a particular animal or one or more specific geographic locations. The geographic locations can be determined based on the GPS coordinates of the HCD 40, which may have been received with the request (Step 205). The instructions can include, for example, HTML (HyperText Markup Language), CSS (Cascading Style Sheets), or JavaScript that, when executed on a web-browser API in the HCD 40 (for example, Microsoft Explorer, Godzilla, Safari) cause the HCD 40 to render and display, for example, a map with animal tracking information, as shown in FIG. 6.

The request can include a request from the HCD 40 to display a heatmap or animal forecast for one or more geographic locations. The request can include global positioning system (GPS) coordinate data for the HCD 40, indicating the location of the HCD 40. If a HEATMAP request is received (HEATMAP, at Step 210), then historical image data can be analyzed by the animal identification unit 184 (shown in FIG. 4) for one or more geographic locations (Step 230) and a heatmap can be generated for the location(s) (Step 235). Heatmap data and instructions can be generated by the user dashboard 190 (shown in FIG. 4) (Step 245) and sent to the HCD 40 to render and display a GUI screen such as, for example, seen in FIG. 7 or FIG. 8 (Step 250). When generating the heatmap data and instructions, the user dashboard 190 can interact with the animal identification unit 184 or animal event predictor 188 (shown in FIG. 4) to generate or retrieve historical tracking data for the particular location(s). The geographic locations can be determined based on the GPS coordinates of the HCD 40 or provided selected by a user via the HDC 40. The instructions can include, for example, HTML, CSS, or JavaScript so that, when executed on a web-browser API in the HCD 40 cause the HCD 40 to render and display, for example, a heatmap for animal activity, as shown in FIG. 7 or FIG. 8.

If a FORECAST request is received (FORECAST, at Step 210), then historical image data can be analyzed by the animal identification unit 184 (shown in FIG. 4) for one or more animals or for one or more geographic locations (Step 240) and prediction data can be generated by the animal event predictor 188 (shown in FIG. 4) based on historical animal activity information for the one or more animals or for the one or more geographic locations (Step 242). The prediction data can include, for example, a predicted likelihood where and when an animal is likely to appear, how long it may remain at the location(s), the direction of arrival or exit by the animal, and a prediction score that can indicate the degree of certainty that the prediction is likely to come to fruition. Prediction data and instructions can be generated by the user dashboard 190 (shown in FIG. 4) (Step 245) and sent to the HCD 40 to render and display a GUI screen such as, for example, seen in FIG. 9 (Step 250). When generating the prediction data and instructions, the user dashboard 190 can interact with the animal identification unit 184, scoring unit 186 or animal event predictor 188 (shown in FIG. 4) to generate or retrieve historical prediction data for the animal or location(s), including score values. The geographic locations can be determined based on the GPS coordinates of the HCD 40 or provided selected by a user via the HDC 40.

In a nonlimiting embodiment, the ITSOP server 100 can receive a request for a communication session directly from the IPU 10-1 (shown in FIG. 2B). In which case, the ITSOP server 100 can open a communication session and receive real-time image data from the IPU 10-1.

Referring back to FIG. 2, in a nonlimiting embodiment, the ITSOP system 1 can link over the air via a radio transceiver for wireless connection to the communication device 40. The ITSOP system 1 can parse incoming data streams, make determinations (scoring or position of shot placement, grouping, repeatability, reproducibility), and transmit display results to the communication device 40 to display the aforementioned. The communication device 40 can be arranged to can make a determination, for example, via a computer application, to share results with groups or individuals and make target selections to be displayed by the communication device 40.

The terms “a,” “an,” and “the,” as used in this disclosure, means “one or more,” unless expressly specified otherwise.

The term “backbone,” as used in this disclosure, means a transmission medium that interconnects one or more computing devices or communicating devices to provide a path that conveys data signals and instruction signals between the one or more computing devices or communicating devices. The backbone can include a bus or a network. The backbone can include an ethernet TCP/IP. The backbone can include a distributed backbone, a collapsed backbone, a parallel backbone or a serial backbone.

The term “bus,” as used in this disclosure, means any of several types of bus structures that can further interconnect to a memory bus (with or without a memory controller), a peripheral bus, or a local bus using any of a variety of commercially available bus architectures. The term “bus” can include a backbone.

The terms “communicating device” and “communication device,” as used in this disclosure, mean any hardware, firmware, or software that can transmit or receive data packets, instruction signals, data signals or radio frequency signals over a communication link. The device can include a computer or a server. The device can be portable or stationary.

The term “communication link,” as used in this disclosure, means a wired or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, WiFi, WiMAX, IEEE 802.11, DECT, 0G, 1G, 2G, 3G, 4G, or 5G cellular standards, or Bluetooth. A communication link can include, for example, an RS-232, RS-422, RS-485, or any other suitable serial interface.

The terms “computer,” “computing device,” or “processor” as used in this disclosure, means any machine, device, circuit, component, or module, or any system of machines, devices, circuits, components, or modules which are capable of manipulating data according to one or more instructions, such as, for example, without limitation, a processor, a microprocessor, a graphics processing unit, a central processing unit, a general purpose computer, a super computer, a personal computer, a laptop computer, a palmtop computer, a notebook computer, a desktop computer, a workstation computer, a server, a server farm, a computer cloud, or an array of processors, microprocessors, central processing units, general purpose computers, super computers, personal computers, laptop computers, palmtop computers, notebook computers, desktop computers, workstation computers, or servers.

The term “computer-readable medium,” as used in this disclosure, means any non-transitory storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read. The computer-readable medium can include a “Cloud,” which includes a distribution of files across multiple (for example, thousands of) memory caches on multiple (for example, thousands of) computers.

Various forms of computer readable media can be involved in carrying sequences of instructions to a computer. For example, sequences of instruction (i) can be delivered from a RAM to a processor, (ii) can be carried over a wireless transmission medium, or (iii) can be formatted according to numerous formats, standards or protocols, including, for example, WiFi, WiMAX, IEEE 802.11, DECT, 0G, 1G, 2G, 3G, 4G, or 5G cellular standards, or Bluetooth.

The term “database,” as used in this disclosure, means any combination of software or hardware, including at least one application or at least one computer. The database can include a structured collection of records or data organized according to a database model, such as, for example, but not limited to at least one of a relational model, a hierarchical model, or a network model. The database can include a database management system application (DBMS) as is known in the art. The at least one application may include, but is not limited to, for example, an application program that can accept connections to service requests from clients by sending back responses to the clients. The database can be configured to run the at least one application, often under heavy workloads, unattended, for extended periods of time with minimal human direction.

The terms “including,” “comprising” and their variations, as used in this disclosure, mean “including, but not limited to,” unless expressly specified otherwise.

The term “network,” as used in this disclosure means, but is not limited to, for example, at least one of a personal area network (PAN), a local area network (LAN), a wireless local area network (WLAN), a campus area network (CAN), a metropolitan area network (MAN), a wide area network (WAN), a metropolitan area network (MAN), a wide area network (WAN), a global area network (GAN), a broadband area network (BAN), a cellular network, a storage-area network (SAN), a system-area network, a passive optical local area network (POLAN), an enterprise private network (EPN), a virtual private network (VPN), the Internet, or the like, or any combination of the foregoing, any of which can be configured to communicate data via a wireless and/or a wired communication medium. These networks can run a variety of protocols, including, but not limited to, for example, Ethernet, IP, IPX, TCP, UDP, SPX, IP, IRC, HTTP, FTP, Telnet, SMTP, DNS, ARP, ICMP.

The term “server,” as used in this disclosure, means any combination of software or hardware, including at least one application or at least one computer to perform services for connected clients as part of a client-server architecture, server-server architecture or client-client architecture. A server can include a mainframe or a server cloud or server farm. The at least one server application can include, but is not limited to, for example, an application program that can accept connections to service requests from clients by sending back responses to the clients. The server can be configured to run the at least one application, often under heavy workloads, unattended, for extended periods of time with minimal human direction. The server can include a plurality of computers configured, with the at least one application being divided among the computers depending upon the workload. For example, under light loading, the at least one application can run on a single computer. However, under heavy loading, multiple computers can be required to run the at least one application. The server, or any if its computers, can also be used as a workstation.

The terms “send,” “sent,” “transmission,” “transmit,” “communication,” “communicate,” “connection,” or “connect,” as used in this disclosure, include the conveyance of data, data packets, computer instructions, or any other digital or analog information via electricity, acoustic waves, light waves or other electromagnetic emissions, such as those generated with communications in the radio frequency (RF), or infrared (IR) spectra. Transmission media for such transmissions can include subatomic particles, atomic particles, molecules (in gas, liquid, or solid form), space, or physical articles such as, for example, coaxial cables, copper wire and fiber optics, including the wires that comprise a system bus coupled to the processor.

Devices that are in communication with each other need not be in continuous communication with each other unless expressly specified otherwise. In addition, devices that are in communication with each other may communicate directly or indirectly through one or more intermediaries.

Although process steps, method steps, or algorithms may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described in this specification may be performed in any order practical. In certain non-limiting embodiments, one or more process steps, method steps, or algorithms can be omitted or skipped.

When a single device or article is described, it will be readily apparent that more than one device or article may be used in place of a single device or article. Similarly, where more than one device or article is described, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A system for identifying or monitoring an animal in a geographic area, the system comprising:
an interface that receives real-time image data from an image pickup device over a cellular communication link;
an animal identification unit arranged to analyze the real-time image data from the image pickup device and identify an animal in the image data, including a species of the animal; and
a user dashboard unit arranged to generate and transmit image rendering data and instruction signals to a hub communication device to render a display image on a graphic user interface that includes at least one of a near-real-time video stream from the image pickup device, an image of the animal, information about the animal, a heatmap, and a forecast.

2. The system in claim 1, wherein the information about the animal includes a score value for the animal, a species of the animal, a historical activity tracking map for the animal, or a predicted activity map for the animal.

3. The system in claim 1, further comprising:
a scoring unit arranged to interact with the animal identification unit and determine a score value for the animal.

4. The system in claim 3, wherein the animal is a Buck and the scoring unit is arranged to determine the score value for the Buck based on a Boone and Crocket Scale.

5. The system in claim 1, further comprising:
an animal event predictor arranged to analyze historical image data and predict an activity for the animal.

6. The system in claim 1, further comprising:
an animal event predictor arranged to analyze historical image data and predict animal activity at a geographic location.

7. The system in claim 1, wherein the hub communication device comprises a smartphone or computer tablet.

8. The method for identifying or monitoring an animal in a geographic area, the method comprising:
receiving real-time image data at an interface from an image pickup device over a cellular communication link;
analyzing the real-time image data by a machine intelligence platform to identify an animal in the image data, including a species of the animal;
generating image rendering data and instruction signals based on the analyzed real-time image data; and
transmitting the image rendering data and instruction signals to a hub communication device to render a display image on a graphic user interface that includes at least one of a near-real-time video stream from the image pickup device, an image of the animal, information about the animal, a heatmap, and a forecast.

9. The method in claim 8, wherein the information about the animal includes a score value for the animal, a species of the animal, a historical activity tracking map for the animal, or a predicted activity map for the animal.

10. The method in claim 8, further comprising:
determining a score value for the animal.

11. The method in claim 10, wherein the animal is a Buck and the scoring determining the score value for the animal comprises performing a Boone and Crocket Scale analysis of the image data.

12. The method in claim 8, further comprising:
analyzing historical image data; and
predicting an activity for the animal.

13. The method in claim 8, further comprising:
analyzing historical image data; and
predicting animal activity at a geographic location.

14. The method in claim 8, wherein the hub communication device comprises a smartphone or computer tablet.

15. A non-transitory computer-readable storage medium storing animal monitoring program instructions for identifying or monitoring an animal in a geographic area, the program instructions comprising the steps of:
receiving real-time image data at an interface from an image pickup device over a cellular communication link;
analyzing the real-time image data by a machine intelligence platform to identify an animal in the image data, including a species of the animal;
generating image rendering data and instruction signals based on the analyzed real-time image data; and
transmitting the image rendering data and instruction signals to a hub communication device to render a display image on a graphic user interface that includes at least one of a near-real-time video stream from the image pickup device, an image of the animal, information about the animal, a heatmap, and a forecast.

16. The storage medium in claim 15, wherein the information about the animal includes a score value for the animal, a species of the animal, a historical activity tracking map for the animal, or a predicted activity map for the animal.

17. The storage medium in claim 15, the program instructions comprising the further step of: further comprising:
determining a score value for the animal.

18. The storage medium in claim 15, wherein the animal is a Buck and the scoring determining the score value for the animal comprises performing a Boone and Crocket Scale analysis of the image data.

19. The storage medium in claim 15, the program instructions comprising the steps of:
analyzing historical image data; and
predicting an activity for the animal.

20. The storage medium in claim 15, the program instructions comprising the steps of:
analyzing historical image data; and
predicting animal activity at a geographic location.

21. The storage medium in claim 15, wherein the hub communication device comprises a smartphone or computer tablet.
